(19) United States
(12) Patent Application Publication
(10) Pub. No.: US 2002/0176361 A1
(43) Pub. Date: Nov. 28, 2002

(54) End-to-end traffic management and adaptive multi-hop multimedia transmission

(76) Inventors: Yunnan Wu, Princeton, NJ (US); Anthony Vetro, Staten Island, NY (US); Huifang Sun, Cranbury, NJ (US); Sun-Yuan Kung, Princeton, NJ (US)

Correspondence Address: Patent Department, Mitsubishi Electric Research Laboratories, Inc., 201 Broadway, Cambridge, MA, 02139, US

(21) Appl. No.: 09/866,399

(22) Filed: May 25, 2001

(51) Int. Cl. H04L 12/26; H04L 12/56

(52) U.S. Cl. 370/231; 370/235; 370/389; 370/412

(57) ABSTRACT

A method manages traffic over a channel of a network connecting a sender end system and a receiver end system. The traffic includes multimedia packets. The channel is modeled as a queue having an associated queue occupancy. The times when packets are sent and the times when feedback messages are received are maintained in the sender end system. A time series of samples for a service time experienced by each packet sent is updated based on the total number of packets sent and the total number of feedback messages received. A queue occupancy for a next packet to be sent is then predicted based on the time series, and the next packet is sent according to the predicted queue occupancy.

### FIELD OF THE INVENTION

The present invention relates generally to the field of network communications, and more particularly to traffic management and content adaptation for multimedia content in a heterogeneous network.

### BACKGROUND OF THE INVENTION

It is a challenge to transmit multimedia content, from a sender end system to a receiver end system, over heterogeneous networks such as the Internet. The TCP/IP protocol stack in the Internet includes a physical layer, a link layer, a network layer, a transport layer, and an application layer. The lower layers, i.e. network layer and below, provide simple per-packet operations to deliver an addressed packet from the sender to the receiver at best effort, while high-layers, i.e. transport layer and above, provide congestion control by appropriate coordination between the sender and the receiver end systems.

This service model poses major problems with respect to transmitting multimedia. First, the core of the Internet is stateless by design, and thus inadequate for guaranteed quality-of service (QoS). Second, it is difficult to design software for the end systems that can adapt multimedia to the dynamic characteristics of the network, in part due to its heterogeneity.

Adaptive transmission strategies have been developed in two aspects: determining how to transmit data, and determining what to transmit to best utilize the network resource. These aspects are referred to as traffic management and content adaptation, respectively. In the case of best-effort networks, such as today's Internet, traffic management is concerned with congestion control, i.e., to avoid injecting more traffic than the network can handle, and also to guarantee the fairness among the competing flows in sharing the network resources.

Traffic management is essential for the “health” of the network, and the efficiency of the connection. While stability is essential, abrupt actions can adversely affect multimedia traffic. While the AIMD (Additive Increase, Multiplicative Decrease) window control of TCP works well for reliable data transport, the inherent “saw-tooth” window evolution, namely the oscillation of the sending rate, makes AIMD unsuitable for multimedia streaming data. Particularly, when the data is a “live” video where future bit rate requirements are unknown. Recently, so called TCP-friendly solutions use steady state TCP throughput models that consider packet loss ratio and round trip time, to adjust the sending rate. However, a steady state model is less than optimal for regulating transient behaviors of streaming data, such as a “live” video feed.

Congestion avoidance methods can predict and control the network state to prevent congestion in the first place. For example, L. Brakmo and L. Peterson, “TCP Vegas: End-to-End Congestion Avoidance on a Global Internet”, IEEE Journal on Select Areas of Communications, vol. 13, No. 8, pages 1465-1480, Oct. 1995, use a heuristic window-based process that adjusts the transmission window linearly when a difference of expected rate and an actual rate is greater than an upper threshold or less than a lower threshold.

H. Kanakia, P. P. Mishra, and A. Reibman, “An adaptive congestion control scheme for real-time packet video transport”, Proc. ACM SIGCOMM, Sept. 1993, determine the bits for every video frame by requiring that intermediate routers feed back queue size information. They predict a bottleneck router queue size evolution over time, and try to keep the bottleneck queue size at a constant level. Their system is effective for adaptive congestion control in a best-effort network, and achieves graceful video quality degradation during network congestion.

However, there are some drawbacks with that method. First, they assume that each router monitors the queue occupancy and the service rate per connection. This information is fed back in response to periodic query packets. Such an assumption is not realistic in today's stateless Internet core. Second, the method directly works with bit allocation for a video frame from feedback on network conditions. That is, the method does not separate the roles of traffic management and content adaptation. Third, the method does not consider packet losses.

Due to the heterogeneity of the network, prior art end-to-end adaptive transmission do not capture network dynamics very well. For example, it is well known that the Internet's Transmission Control Protocol (TCP) suffers from serious performance degradation when running over a path containing a wireless link.

As a partial remedy, proxy servers and filters can be placed in the network. For multimedia multicasts, filters are used to construct a distribution tree to make efficient use of the network resources, and to accommodate end systems with different link bandwidths. When the sending end system is too busy, filters are used in place of the sender to adapt the content during network congestion. Caching and pre-fetching with proxy servers can take advantage of similar access among many end systems. Application level filters can be used as incrementally deployable alternatives to programmable routers for placing user-defined computations into the network. Real-time multimedia transcoding is a specific example.

Efficient collaboration between the filters and the end systems remains a problem. Lack of collaboration can result in inefficiencies, duplication, and negative interaction. Therefore, it is desired to provide a system that coordinates the filters and end systems efficiently in terms of both performance and system resource, especially when dealing with multimedia content in a heterogeneous network.

### SUMMARY OF THE INVENTION

The present invention provides an end-to-end traffic management system and method for multimedia content delivery over best-effort networks. A multi-hop video communication system is also described. Traffic management and content adaptation are done collaboratively by end systems and relays in the network. Multi-hop management achieves higher throughput without increasing the risk of overloading the network, and increasing end-to-end delays. The relays according to the invention include an error withdrawal feature so that abrupt decreases in quality of the content are avoided.

More particularly, the invention provides a method for managing traffic over a channel of a network connecting a sender end system and a receiver end system. The traffic includes multimedia packets. The channel is modeled as a queue having an associated queue occupancy. A time series of samples for a service time experienced by each packet that is sent is updated based on the times when packets are sent and the times when feedback messages are received. A most recent queue occupancy is then predicted based on the time series, and the next packet is sent according to the predicted queue occupancy.

### BRIEF DESCRIPTION OF THE DRAWINGS

FIG. 1 is a block diagram of a communications system that uses end-to-end traffic management according to the invention;

FIG. 2 is a block diagram of a queue model used for end-to-end traffic management according to the invention;

FIG. 3 is a graph of cumulative send and feedback packets, and queue occupancy;

FIG. 4 is a graph of cumulative send packets, throughput at playback times;

FIG. 5 is a flow diagram of a process used by the method according to the invention;

FIG. 6 is a graph of over-allocation and bandwidth reduction;

FIG. 7 is a flow diagram of end-to-end traffic management according to the invention; and

FIG. 8 is a block diagram of a queue model for multi-hop traffic management according to the invention;

### DETAILED DESCRIPTION OF THE PREFERRED EMBODIMENT

End-to-End Traffic Management

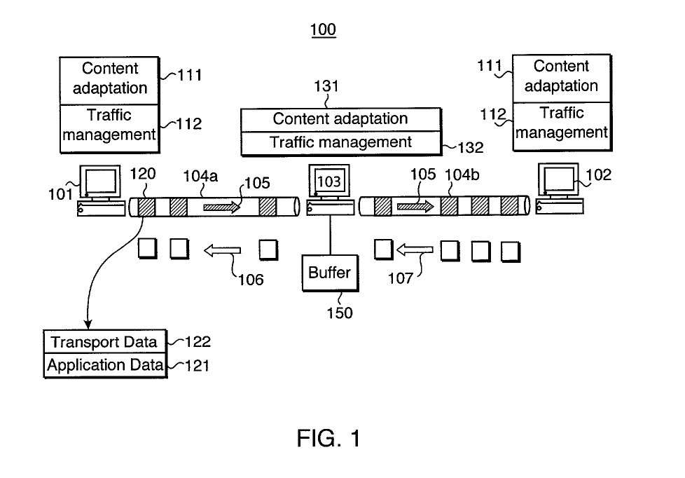

FIG. 1 shows a communication system 100 according to the invention. The system 100 includes at least two end systems 101-102 connected via a communications channel 104a-b. The end systems 101-102 can be client or server system that can send or receive multimedia data (traffic) 105, at any one time. The end systems can be of varying complexity and design, including wireless telephones, PDAs, laptops, PCs, workstations, and larger scale servers.

At the end systems 101-102, the channel is presented as links 104a-b. Each end system includes a traffic management module 112 and content adaptation module 111. The traffic management 112 and the content adaptation module 111 are implemented at independent high-level layers of the network protocol stack, as described in greater detail below, i.e., above the network layer.

The communications channel 104a-b is shown in a highly simplified form. In practice, the channel passes though many intermediate switches, firewalls, gateways, routers. At the physical layer, the channel can include, wire, wireless, RF, infra-red, micro-wave wireless and satellite links, co-axial and optical cables, each having their own bandwidth characteristic. The network can include the world-wide telephone system, the Internet, the World-Wide-Web, broadband, baseband, broadcast, satellite, and multicast networks.

In one embodiment, a multi-hop version of the system 100 can include one or relays 103, described in greater detail below.

Feedback Messages

In response to receiving packets, the receiver 102 sends feedback messages 106-107 upstream, with respect to the flow of the traffic 105 from the sender end system 101 to the receiver end system 102. Each feedback message 120 comprises two parts: application feedback data 121 and transport feedback data 122. These data are suitable for processing by the content adaptation layers and the traffic management layers 111-112, respectively. Specifics of the feedback messages are described in greater detail below.

End-to-end traffic management 112 according to the invention includes two phases: a learning phase and a near steady phase. During the learning phase, data are transmitted at a relative slow and “safe” constant rate to collect a history of feedback messages. Essentially, the network characteristics are “learned” or determined without overloading the system. After the learning phase, the data rate is adapted to best utilize the available bandwidth without congestion in the near steady phase.

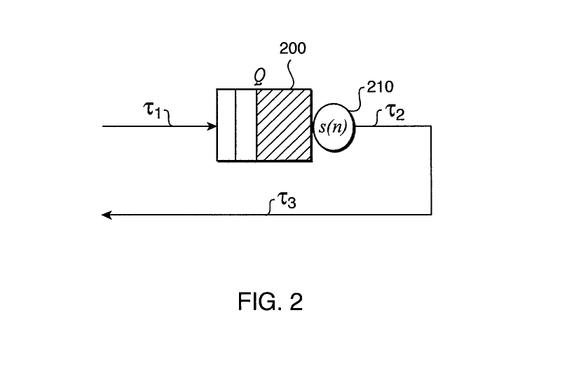

As shown in FIG. 2, the end-to-end channel 104a-b can be modeled as a FIFO queue Q 200 and delay elements τ₁, τ₂, τ₃. Of course in a real network, the channel contains an unknown number of routers, switches and data links with various unknown bandwidths and traffic patterns and delays.

The total amount of delay, aside from a time-varying packet service time at the queue, is τ=(τ₁+τ₂+τ₃). Due to random shared access by many competing connections, the packet service time at the queue on the channel 104 is modeled by a random time series s(n) 210, where n represents a packet number. The time series 210 is locally stationary.

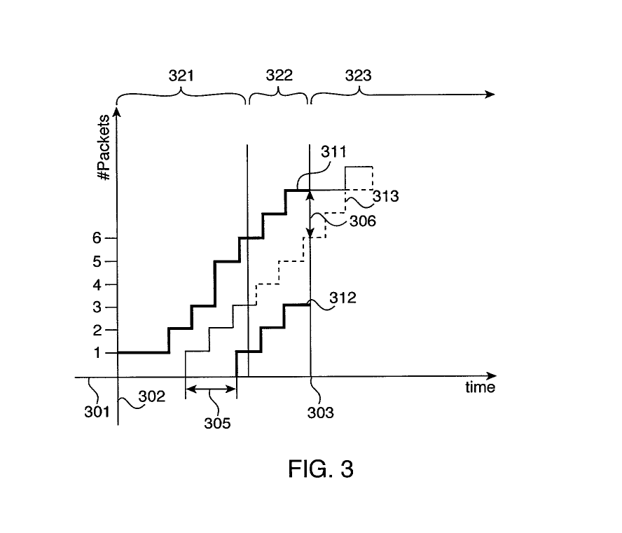

FIG. 3 models the traffic management at the sender 101. The x-axis 301 indicates time, and the y-axis 302 the cumulative number of packets sent. At a current time 303, the sender's process maintains a cumulative packet sending curve 311, i.e., the total number of packets sent at any point in time, and a cumulative feedback curve 312. The two curves essentially “count” the total of number of packets sent and received on the channel over time. In order to determine the input and output rate at the queue 200, the cumulative feedback curve 312 is shifted back the delay time τ₁+τ₂+τ₃ 305 to a position 313.

This divides the time axis 301 into three time intervals 321-323. Time interval 321 corresponds to packets sent and acknowledged by the receiver 102, interval 322 corresponds to packets sent but not acknowledged, and interval 323 corresponds to unsent packets. At a current time 303, the vertical difference 306 between the cumulative sending curve 311 and the shifted cumulative feedback curve 313 models queue occupancy. The queue occupancy reflects the amount space in the queue is used, e.g., an occupancy of zero could mean the queue is empty and an occupancy of one means the queue is full. For a particular packet, the horizontal difference 305 between the two curves 311-313 models the time spent in the queue, i.e., the service time.

In order to estimate a most recent queue occupancy and to regulate the transmission of packets in the future, the time series s(n) 210 is predicted some period ahead in time. For longer prediction periods, local details become less important.

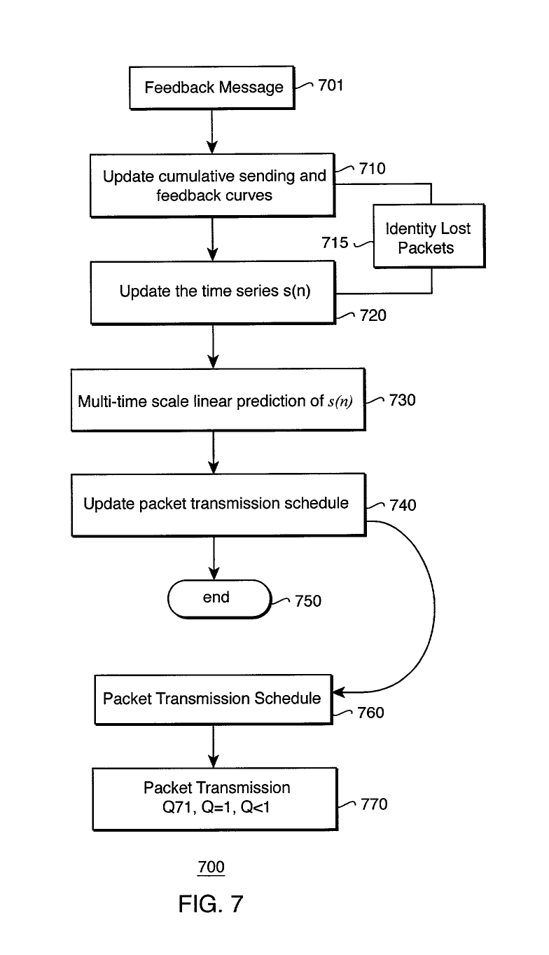

Therefore, the traffic management module 112 according to the invention uses a multi-timescale linear prediction method 700 as shown in FIG. 7. The process 700 is responsive to feedback messages 701. When a feedback message is received, the cumulative sending curve 311 and the cumulative feedback curve 312 are updated 710 to reflect an advance in time. For the interval 321, a time sample t_{S} is added 720 to the time series s(n) 210 for each packet sent, where: t_{S}=departure time of packet n−max(departure time of packet n−1, arrival time of packet n).

The departure time and the arrival time are both with respect to the queue 200.

The multi-timescale linear prediction 730 predicts the time series s(n) some steps ahead. This is done by subtracting the mean μ for the observed time series s(n) from each s(n) to produce a zero-mean time series. The zero-mean time series is then passed to the zero-mean multi-timescale linear prediction. After the prediction, the mean is added back to get the prediction output, and the method terminates 750 until a next feedback message is received.

The zero-mean multi-timescale linear prediction 730 can be performed by known decimation, linear prediction and interpolation in a series with a decimation factor of 2 k in a k-th timescale. In this way, at any timescale, two steps ahead can be predicted. The taps of a prediction finite impulse response (FIR) filter can be obtained by the Yule-Walker equation, or using an adaptive filtering algorithm such as LMS, see S. Haykin, “Adaptive Filter Theory,” Third Edition, Prentice-Hall, 1996.

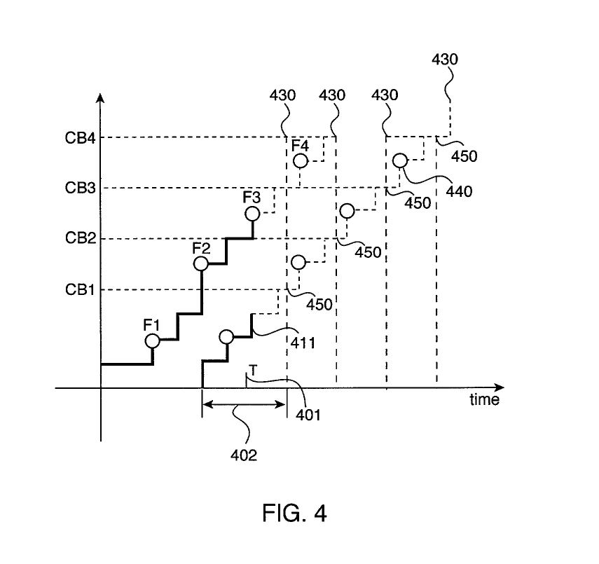

The prediction can then be used to update the packet transmission schedule 760 for a small number of next packets. With the observed and predicted service time series s(n), the departure times from the queue can be determined for all the packets that have been sent. With respect to the model of FIG. 4, this means that the shifted cumulative feedback curve 313 can be extended. The estimated queue occupancy at the boundaries of the intervals 321-323 is represented by the vertical distance 306 between the sending curve 311 and the sending feedback curve 313, at the current time 303.

Transmission 770 of the next few packets is then regulated to gradually drive the queue occupancy to the desired queue occupancy. A simple analysis with the M/M/1 queue model suggests setting the queue length to be one, see M. Schwartz, “Broadband integrated networks,” Prentice-Hall, 1996. An M/M/1 queue has a Poison arrival time, and an exponential service time, and a single server. If the estimated queue occupancy is less than one (Q<1), then one packet is transmitted immediately, and another packet is transmitted whenever a feedback message from a previous packet is received. Otherwise, if the estimated queue occupancy is one (Q=1), transmit a next packet whenever a feedback message for a previous sent packet is received. And otherwise, if the estimated queue occupancy is greater than one (Q>1), transmit the next packet until the queue occupancy again becomes one.

Although this prediction process avoids most congestion, packet loss can also happen due to errors in the prediction. Because a packet is dropped when there is no room in the queue Q 200, congestion loss signals the size of the available queue occupancy for the channel. For example, if it determined that packet #2 is lost when the feedback of packet #3 arrives, then the available queue occupancy can be updated.

Similarly, when a packet gets through, another sample of the available queue occupancy is collected. Therefore, instead of going directly from step 710 to step 720, an alternative path through step 715 identifies those packets lost since the last feedback message based on sequence number information in the feedback message.

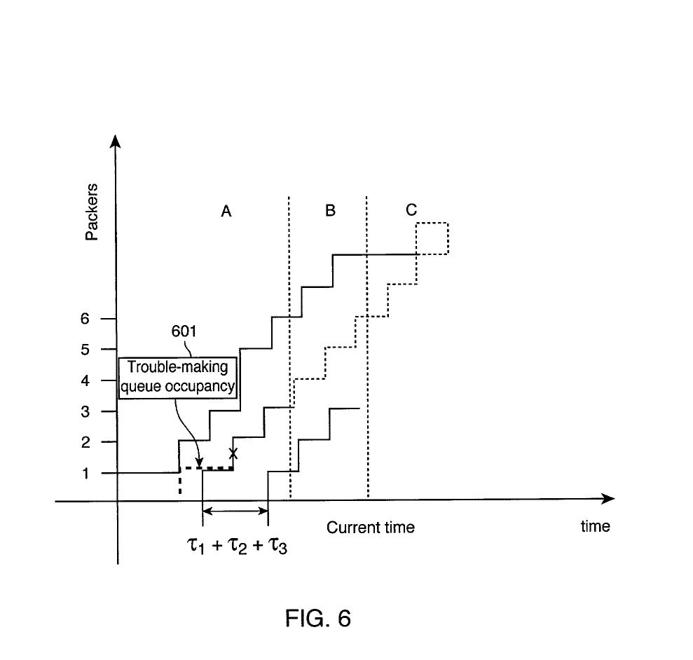

Because a packet is dropped when there is no room in the queue, packet loss signals the size of the available queue occupancy for the connection. For every packet lost, a “trouble-making” queue occupancy 601 curve, see FIG. 6, can be determined from the sending and shifted feedback curves. Then, update the available queue occupancy according to the following equation:

new_{—}q_occupancy=min(old_{—}q_occupancy, “trouble-making” queue occupancy−1).

Similarly, when a packet arrives successfully, collect another sample of the available queue occupancy. For every successfully sent packet, the “healthy” queue occupancy 306 is inferred, and the available queue occupancy is updated according to:

new_{—}q_occupancy=max(old_{—}q_occupancy, “healthy” queue occupancy).

The available queue occupancy information can also be used in estimating the queue occupancy for interval 322, this is, packets sent but not acknowledged. This leads to a modified queue occupancy estimation step. If the queue occupancy is too large when a packet arrives, then a packet loss can be predicted. The modified queue occupancy estimation continues assuming the packet is discarded. Such an early loss warning can also be useful for a video encoder. The encoder can avoid using that packet for a reference frame to reduce error propagation. The available queue occupancy can also be used to control the speed the queue occupancy is driven to the desired value. If the available queue occupancy is large, the speed of control can be slow, and vice versa.

So far, the traffic management method 700 assumes a steady inverse flow of feedback messages. However, the feedback can be compressed to reduce the amount of control traffic. Because the sender is doing prediction, a feedback message can be avoided when a new sample of the time series is predictable. In this case, the prediction of the sender can be used instead.

Multi-Hop Video Transmission System

FIG. 1 also shows that one or more relays 103 can be inserted between the end systems 101-102. In this case, the relays 103 can also processes the feedback messages 106-107. At each relay 103, the channel is presented as an input link 104a and an output link 104b. In contrast to the end-to-end traffic management described above, where only the end systems 101-102 perform traffic management and content adaptation, here the relays 103 provide traffic management and content adaptation within the network. As before, traffic management and content adaptation modules 131-132 are implemented at independent high-level layers of the network protocol stack. The relay 103 also includes a buffer 150 for temporarily holding received data and feedback messages.

The one or more relays 103 can perform as: observer, advisor, and controller. A particular relay can perform one, or a combination of these functions. As an observer, the relay collects QoS information for the input and output links to which it is directly connected, and the traffic flow it is monitoring. As an advisor, the relay provides content adaptation predictions and suggestions based on the QoS information collected by observer relays. For example, packet coloring can be used to assess priority relations. As a controller, the relay performs traffic management and content adaptation, taking into consideration the resource tradeoff of multiple competing connections. In other words, the relays enable the monitoring and adapting of traffic state inside an otherwise stateless network.

Unlike prior art routers, which commonly performs only per-packet processing at the lower layers of the communications protocol, the relays 103 according to the invention can identify a traffic flow, that is a sequence or “flow” of related packets, such as a video or audio program. Hence, higher level adaptation and management can be provided. Also, the blocks representing the upper layers 131-132 are intentionally shown to be “thinner” in FIG. 1 to emphasize that they are considerably less complex than the comparable layers 111-112 in the end systems 101-102.

Separated Traffic Management and Content Adaptation

The two layered modules 131-132 are implemented as two distinct processes with well defined interfaces. Thus, the layers 131-132 can operate independent of each other. Balakrishnan et al. in “An Integrated Congestion Management Architecture for Internet Hosts,” Proc. ACM SIGCOMM, Sept. 1999, describe sharing congestion control among connections with identical source and destination pairs at an end host. Here, the separated design of modules 131-132 at the relay can share the traffic management among peer connections with identical relay and destination, (or another relay) pairs. Sharing of traffic management also means some common feedback packets for network link condition can be reduced. Because the relay is assumed to serve more than one connection, sharing is predicted to happen more frequently. Thus, it is advantageous and cost-effective to have a common traffic management.

With the multi-hop system 100 according to the invention, the QoS problem in the stateless Internet is addressed by coordinating traffic management and content adaptation not only in the end systems, but also in the relays which now can maintain state of the traffic and content in the otherwise stateless network.

Multi-Hop Traffic Management

In the multi-hop management system 100 there are at least two control loops, one for the input 104a, and another one for the output link 104b. Because these two loops are always shorter than the total end-to-end loop, the relay 103 can better track the network state, and react more quickly to changes in the network state.

In this case, the traffic management includes learning, speed-up, and steady phases. During the learning phase, packets are transmitted slowly to learn the network characteristics. During speed-up phase, each local loop runs at a maximal speed to best utilize the available bandwidth without congestion.

Consider the case of a high-bandwidth Internet channel connected to a downstream low-bandwidth wireless channel. Because of the mismatch in the throughput of the different loops, the traffic is buffered at the relays before the bottleneck builds up. In the long run, the faster loops are constrained by a bottleneck slower channel. Such a constraint can be applied to the traffic management module by estimating a throughput at the receiver 102, and keeping the total outstanding packets in the system roughly at a constant value. This corresponds to the steady phase.

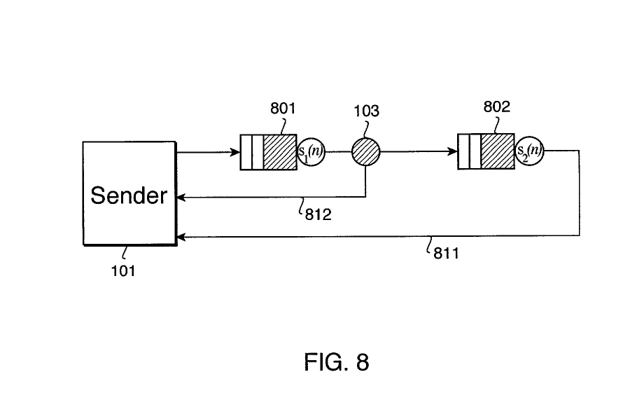

FIG. 8 shows a model 800 of the multi-hop system 100 with multiple loops. Here, the system can be modeled by multiple queues 801 and 802, one for each loop. In this case, the sender 101 receives multiple feedback flows: one flow 811 from the receiver 102, and one flow 812 from each relay in the end-to-end path. Therefore, the sender 101 performs multiple predictions, one for each feedback flow.

Now, in the packet transmitter 770 of FIG. 7, a total cumulative sending at the sender 101 and a total cumulative arriving at the receiver 102 can be considered. Packets are scheduled at first according to the local loop, that is, based on the cumulative sending at the sender and the cumulative feed back from the relay. If is these are within the buffer constraints, then the packet transmission is scheduled. Otherwise, transmission of the next packet is deferred by a time unit, and test again.

Multi-Hop Content Adaptation

Given the available bandwidth determined by the traffic management module, the content adaptation module schedules the data to be transmitted. When the available bandwidth is limited, transcoding may be applied to gracefully degrade the quality. Performing one adaptation over another depends on the characteristics of the content, the playback time constraints, and the available bandwidth. This is often formulated as a rate-distortion (R-D) optimization problem. Hsu et al., in “Rate controlfor robust video transmission over burst-error wireless channels,” IEEE JSAC, vol. 17, no. 5, May. 1999, described optimized video adaptation with playback time constraints for variable bit-error-rate wireless channel. They showed that the delay constraints are equivalent to bit budget constraints from future channel rates.

In the multi-hop management system, both the sender 101 and the relay 103 can perform content adaptation. There is a trade-off as whether the adaptation should be sender-centric or relay-centric.

As shown in FIG. 1, the data traffic flow from the sender 101 to the receiver 102 and the feedback messages 106-107 travel the opposite way. Therefore, the sender 102 has better knowledge of the content state while the relay 103 has better knowledge of the traffic state.

When a high bandwidth link is connected to a low bandwidth link at the relay 103, a large buffer 150 can be allocated at the relay 103 to gain content knowledge. An application for this strategy is at the edge of the network. The internal links of the network may operate at rates of 10 Mbps or higher. However, the last hop in the network, from a relay, e.g. a cellular base station, to a portable end system, e.g. a cell phone, is via a wireless link operating nominally at 10 Kbps. This is a thousand-fold drop in bandwidth. Hence, a relatively large buffer can be allocated in trade-off for the better content knowledge.

Alternative, it is possible for the relay 103 to acquire knowledge about future content by transmitting a content outline before transmitting the actual content. Then, the relay can “learn” the characteristics of the content to be sent ahead of time.

However, both solutions consume system resources and more bandwidth than necessary. Consequently, the system 100 prefers a sender-centric adaptation, and use the content adaptation module 131 at the relay 103 to “withdraw” erroneous over-allocation made by the sender 101 when there is a sudden decrease in the available bandwidth. Because the over-allocation withdrawal property is only called for when there is a sudden drop in bandwidth, it has minimal impact on processing delay.

Content Adaptation Procedure

A sliding window content adaptation procedure is used for rate-distortion optimized resource allocation with delay constraints. The adaptation procedure is applicable to both the sender 101 and the relay 103. Although prior art sender adaptation can be adapted to work at the relay, there are two additional requirements: the inputs to the relay are on-line data streams that may be subject to packet loss, bit error, delay, and delay jitter, and the relay minimizes latency.

As shown in FIG. 4, where the current time is T 401 and a start-up delay is D 402, the y-axis indicates the cumulative bits (CB) at the end of each frame of a video, the throughput curve 411 fed back from the receiver 102 maps the playback time constraints into bit budget constraints. Obviously, each frame (F1, . . . , F4) must arrive before its scheduled playback time

Because the adaptation refers to future throughput, the throughput curve 411 has to be predicted by the traffic management module. The playback times are shown as vertical dashed lines 430. Equivalently, this means that the cumulative bits (CB#) used must be less than a bound at intersections 450 between the throughput curve 41 land the playback times 430 of the frames.

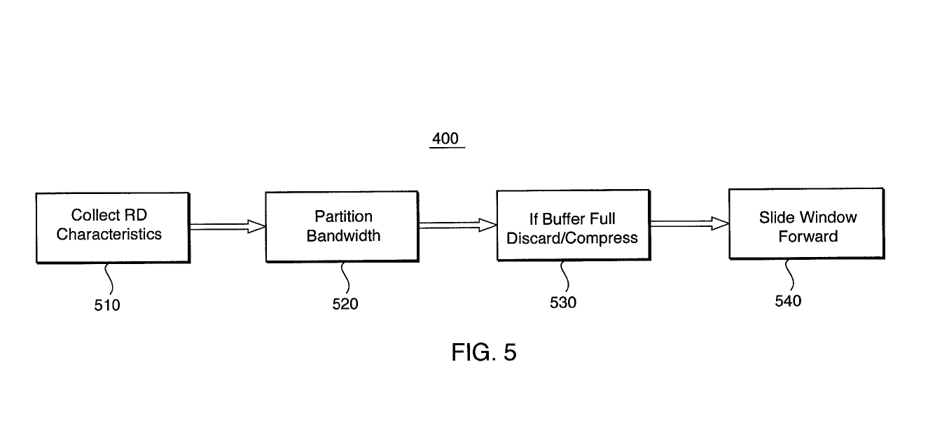

FIG. 5 shows the step of the content adaptation procedure 500 according to the invention. For all the frames in the buffer, i.e., within the current window, step 510 collects the rate-distortion (RD) characteristics. Step 520 partitions the available bandwidth into shares for each frame, while minimizing the received distortion under the bit budget constraints. This optimization problem can be solved with dynamic programming, or the Lagrange multiplier, see Hsu et al. above. If the buffer is full when the frame arrives, step 530 compresses the buffered data if possible, otherwise the frame is discarded. When the frame is transmitted, step 540 slides the window forward to the next frame.

Over-Allocation Withdrawal

The relay 103 can coordinate with the sender to do more than just buffer the content in transit from the sender to the receiver. The sender has full access to the content, and hence, the sender can do long-term prediction for bandwidth allocation. However, because the sender can sometimes incorrectly estimate future available bandwidth due to rapidly changing conditions in the network, bandwidth may be either over, or under allocated. Over allocation wastes network resources, and under allocation can degrade quality.

For example with reference to FIG. 6, which also plots cumulative bits (CB) versus time, frame F3 was over-allocated. However, when the relay 103 determines the bandwidth allocation for frame F2, the relay can realize an over-allocation for frame F3 before it is sent out from the relay. This results on a reduced bandwidth allocation for frame F3, as shown with by arrow 500.

Consequently, if the relay 103 notifies the sender 101 of the reduced allocation, then the sender can perform allocation assuming some previous over-allocation has been withdrawn. This is equivalent to reducing the current allocation, namely the total bits consumed by all previous frames.

Signaling overhead can be reduced if the sender predicts the reduction behavior at the relay 103. The sender does not need to predict what is reduced, instead the sender only predicts how much data are to be reduced. Specifically, the number of feedback messages sent by the receiver end system could be reduced when the predicted queue occupancy is within a predetermined error measure.

The sender can check all the frames, from the oldest to the newest, that have been sent but not acknowledged by the receiver 102. If a particular frame exceeds the frame playback time, the sender can assume that the relay 103 will reduce the frame to the frame playback time, and adjusts the total bits consumed.

Although the invention has been described by way of examples of preferred embodiments, it is to be understood that various other adaptations and modifications can be made within the spirit and scope of the invention. Therefore, it is the object of the appended claims to cover all such variations and modifications.

We claims:

1. A method for managing traffic over a channel of a network connecting a sender end system and a receiver end system, the traffic including a plurality of packets, comprising:
modeling the channel as a queue having an associated queue occupancy;
maintaining, in the sender end system, a series of times when packets are sent and a series of times when feedback messages are received by the sender system in response to receiving the feedback messages in the sender end system indicating the packets were received by the receiver end system;
updating a time series of samples for a service time experienced by each packet sent based on the series of times when the packets are sent and the feedback messages are received;
predicting a most recent queue occupancy based on the time series of samples; and
sending the next packet according to the predicted queue occupancy.

2. The method of claim 1 further comprising
sending the next packet immediately if the queue occupancy is less than one; otherwise
sending the next packet when the feedback message is received for a current packet if the queue occupancy is one; and otherwise
delaying sending the next packet until the queue occupancy is one.

3. The method of claim 1 wherein the predicting uses a multi-timescale linear prediction method.

4. The method of claim 1 wherein each sample t_{S} equals a departure time of a packet n−maximum(departure time of a packet n−1, arrival time of the packet n).

5. The method of claim 3 further comprising: subtracting a mean μ for the time series from each pair of samples to produce a zero-mean time series for the predicting.

6. The method of claim 1 further comprising:
counting lost packets;
inferring and updating the available queue occupancy considering the lost packets when predicting the queue occupancy; and
using the available queue occupancy to determine a speed of congestion control.

7. The method of claim 1 wherein the available queue occupancy is used to predict packet loss and to inform an encoder.

8. The method of claim 1 wherein the sender end system is connected to the receiver end system via a relay, and the channel includes a link from the sender end system to the relay and a link from the relay to the receiver end system.

9. The method of claim 8 further comprising:
predicting a first queue occupancy for a first link at the sender;
predicting a relay buffer fullness at the sender; and
predicting a second queue occupancy for a second link at the relay.

10. The method of claim 1 wherein each feedback message includes application feedback data and transport feedback data.

11. The method of claim 1 further comprising:
reducing a number of feedback messages sent by the receiver end system when the predicted queue occupancy is within a predetermined error measure.

12. The method of claim 8 wherein the relay includes independently operating traffic management and content adaptation modules.

13. The method of claim 8 wherein the sender and the relay form a first control loop, and the relay and the receiver form a second control loop.

14. The method of claim 12 wherein the content adaptation module withdraws over-allocation at the relay when the sender over-allocates bandwidth.

15. The method of claim 14 wherein the sender updates a total bits allocated based on an over-allocation withdrawal at the relay.

16. A system for managing traffic over a channel of a network connecting a sender end system and a receiver end system, the traffic including a plurality of packets, comprising:
means for modeling the channel as a queue having an associated queue occupancy;
means for maintaining, in the sender end system, a series of times when packets are sent and a series of times when feedback messaged are received by the sender system in response to receiving the feedback messages in the sender end system indicating the packets were received by the receiver end system;
means for updating a time series of samples for a service time experienced by each packet sent based on the series of times when the packets are sent and the feedback messages are received;
means for predicting a most recent queue occupancy based on the time series of samples; and
means for sending the next packet according to the predicted queue occupancy.
